(19) United States
(12) Patent Application Publication
(10) Pub. No.: US 2025/0212050 A1
(43) Pub. Date: Jun. 26, 2025

(54) WIRELESS COMMUNICATION APPARATUS AND WIRELESS COMMUNICATION METHOD

(71) Applicant: SONY GROUP CORPORATION, TOKYO (JP)

(72) Inventors: YUYA IWASAKI, TOKYO (JP); TAKUYA IWAI, TOKYO (JP)

(21) Appl. No.: 18/848,726

(22) PCT Filed: Mar. 13, 2023
(86) PCT No.: PCT/JP2023/009497

§ 371 Date: Sep. 19, 2024

(30) Foreign Application Priority Data
Mar. 29, 2022 (JP) 2022-053270

(51) Int. Cl. H04W 28/02

(52) U.S. Cl. CPC H04W 28/0278; H04W 28/0268

(57) ABSTRACT

The present technology relates to a wireless communication apparatus and wireless communication method capable of reducing degradation in video quality in a case where a characteristic of a communication channel deteriorates. The wireless communication apparatus controls transmission of a packet using a plurality of communication channels, transmits the packet by using a first communication channel, transmits the packet by using a second communication channel, and temporarily accumulates the packet in a transmission buffer. Then, in a case where a characteristic of the first communication channel deteriorates during transmission of the packet using the first communication channel, the wireless communication apparatus reads, from the transmission buffer, the packet of which transmission on the first communication channel is not completed, and controls transmission of the read packet by using the second communication channel. The present technology can be applied to a wireless communication system.

### TECHNICAL FIELD

The present technology relates to a wireless communication apparatus and a wireless communication method, and more particularly, to a wireless communication apparatus and wireless communication method capable of reducing degradation in video quality in a case where a characteristic of a communication channel deteriorates.

### BACKGROUND ART

It is conceivable that a system configuration having a plurality of communication channels is adopted in a case where a communication network, such as Long Term Evolution (LTE) or 5G, is used to handle content, such as remote control or X-Realty (XR), that is strict about delays.

Because all-time use of a plurality of communication channels for transmission of redundant data is inefficient, in a case where a characteristic of a communication channel in use deteriorates, as in deterioration in a radio wave environment or a handover, it is conceivable to perform control to switch to another communication channel.

In this regard, however, at this time, depending on a timing of switching the communication channel, a large amount of data remains in a buffer of a wireless communication unit in a terminal or base station, and when switching to the another communication channel, data may not be transmitted starting with appropriate data.

For this reason, for example, in a case of video data and where a handover occurs while an I-frame is being transmitted on a communication channel that is used first, a state occurs in which the I-frame appears to have been transmitted in an application although a corresponding packet is actually remaining in the wireless communication unit. At this time, if an operation is performed on another communication channel to start transmission with a subsequent P-frame, necessary data may not be delivered in spite of the switching of the communication channel, resulting in a disturbance in a video image.

For example, Patent Document 1 describes a technique of recognizing characteristics of respective communication channels and selecting a communication channel for transmitting video data according to communication quality and priority, as in determining an upper limit of each communication amount to assign transmission data, understanding a handover timing to change a transmission method, or assigning transmission data to another wireless communication unit having a different coverage.

### CITATION LIST

### Patent Document

Patent Document 1: Japanese Patent Application Laid-Open No. 2020-36156

### SUMMARY OF THE INVENTION

### Problems to be Solved by the Invention

However, in the technique described in Patent Document 1, it is difficult to correspond to content for which it is strict about delays, because it is not considered that data remains in a buffer of a wireless communication unit in a case where deterioration of a communication channel environment and a handover accompanying the deterioration occur, because there is no function of monitoring packets.

The present technology has been made in view of such a situation, and an object thereof is to reduce degradation in video quality in a case where a characteristic of a communication channel deteriorates.

### Solutions to Problems

A wireless communication apparatus according to one aspect of the present technology includes a transmission control unit that controls transmission of a packet using a plurality of communication channels, a first wireless communication unit that transmits the packet by using a first communication channel, a second wireless communication unit that transmits the packet by using a second communication channel, and a transmission buffer that temporarily accumulates the packet, in which, in a case where a characteristic of the first communication channel deteriorates during transmission of the packet using the first communication channel, the transmission control unit reads, from the transmission buffer, the packet of which transmission on the first communication channel is not completed, and controls transmission of the read packet by using the second communication channel.

In one aspect of the present technology, transmission of a packet using the plurality of communication channels is controlled, the packet is transmitted by using a first communication channel, the packet is transmitted by using a second communication channel, and the packet is temporarily accumulated in a transmission buffer. Then, in a case where a characteristic of the first communication channel deteriorates during transmission of the packet using the first communication channel, the packet of which transmission on the first communication channel is not completed is read from the transmission buffer, and transmission of the read packet using the second communication channel is controlled.

### BRIEF DESCRIPTION OF DRAWINGS

FIG. 1 is a diagram illustrating a configuration example of a wireless communication system according to an embodiment of the present technology.

FIG. 2 is a block diagram illustrating a functional configuration example of each unit of a terminal in FIG. 1.

FIG. 3 is a diagram illustrating a sequence of transmitting video data in the wireless communication system in FIG. 1, in a case of a packet that constitutes an I-frame.

FIG. 4 is a diagram illustrating a sequence of transmitting the video data in the wireless communication system 1 in FIG. 1, in a case of a packet that constitutes a frame other than the I-frame.

FIG. 5 is a diagram illustrating a configuration example of packet status management data.

FIG. 6 is a diagram illustrating details of the packet status management data in FIG. 5.

FIG. 7 is a diagram illustrating a first sequence for performing processing of monitoring a packet transmission status in the wireless communication unit at a timing t5 in FIG. 3.

FIG. 8 is a diagram illustrating a second sequence for performing processing of monitoring a packet transmission status in the wireless communication unit at the timing t5 in FIG. 3.

FIG. 9 is a diagram illustrating a communication channel switching sequence accompanying a handover, in a case of the packet that constitutes the I-frame.

FIG. 10 is a diagram illustrating an un-transmitted packet re-transmission processing sequence at a timing t84 in FIG. 9.

FIG. 11 is a diagram illustrating a communication channel switching sequence accompanying a handover, in a case of a packet that constitutes a frame other than the I-frame.

FIG. 12 is a block diagram illustrating a configuration example of a computer.

### MODE FOR CARRYING OUT THE INVENTION

Hereinafter, a mode for carrying out the present technology will be described. The description will be made in the following order.
1. Embodiment (Wireless Communication System)
2. Modifications
3. Others

### 1. First Embodiment

### <Configuration Example of Wireless Communication System>

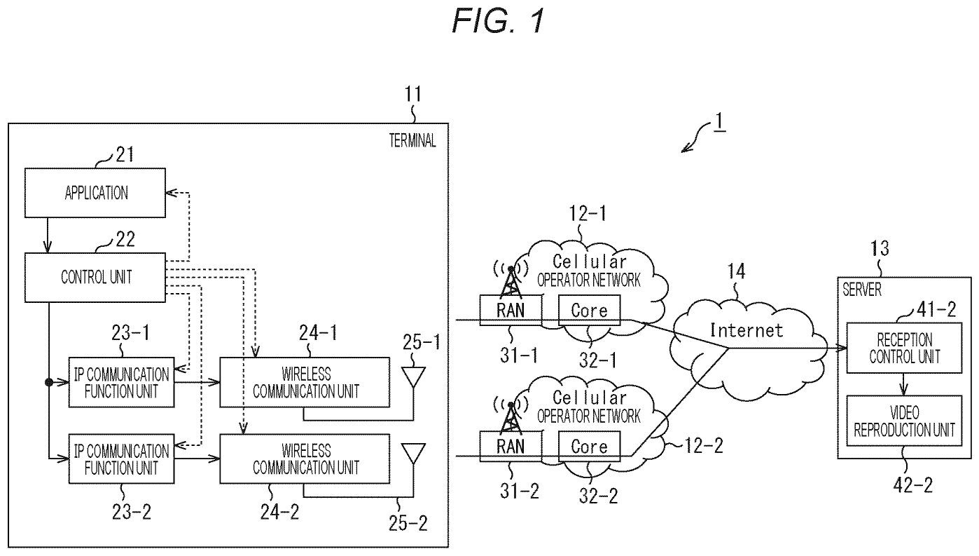

FIG. 1 is a diagram illustrating a configuration example of a wireless communication system according to an embodiment of the present technology.

A wireless communication system 1 in FIG. 1 has a wireless communication system having a plurality of communication channels.

The wireless communication system 1 includes a terminal 11, a plurality of cellular operator networks 12-1 and 12-2, a server 13 that receives content, and the Internet 14. The cellular operator networks 12-1 and 12-2 will be referred to as a cellular operator network 12 in a case where they are not particularly need to be distinguished from each other.

The terminal 11 and the cellular operator network 12 are connected by wireless communication. The cellular operator network 12 and the server 13 are connected via the Internet 14.

The terminal 11 is a terminal for content distribution, is connected to the cellular operator network 12 by using wireless communication technology such as LTE or 5G, and accesses the server 13 on the Internet 14 via a plurality of communication channels.

The terminal 11 includes an application 21, a control unit 22, IP communication function units 23-1 and 23-2, wireless communication units 24-1 and 24-2, and antennas 25-1 and 25-2.

The IP communication function units 23-1 and 23-2, the wireless communication units 24-1 and 24-2, and the antennas 25-1 and 25-2 are referred to as an IP communication function unit 23, a wireless communication unit 24, and an antenna 25, respectively, in a case where they are not particularly need to be distinguished from each other.

Furthermore, in the terminal 11, the solid arrows indicate a flow of data, and the dashed arrows indicate packet monitoring.

The application 21 controls distribution of video data.

The control unit 22 includes a packet monitoring function and wireless monitoring function that monitor each unit of the terminal 11, and a transmission control function and a buffering function that control transmission on the basis of information from the monitoring functions. The control unit 22 performs control to minimize packet delays and losses when the plurality of communication channels is used by being switched.

The IP communication function unit 23 controls IP communication for each communication channel.

The wireless communication unit 24 has a wireless communication function including Packet Data Convergence Protocol (PDCP), Packet Data Convergence Protocol (RLC), and Packet Data Convergence Protocol (MAC) on the basis of specifications defined by 3rd Generation Partnership Project (3GPP) (registered trademark). The plurality of wireless communication units 24 is connected to different or the same cellular operator network 12, and transmits and receives packets generated from the video data through the plurality of communication channels.

As a combination of communication channels, there is a combination in which enhanced Mobile Broadband (eMBB) and Ultra-Reliable and Low Latency Communications (URLLC) having greatly different communication characteristics are used, and while eMBB is mainly used, only important data is transmitted by using URLLC when a communication characteristic deteriorates. Furthermore, as a combination of communication channels, there is an arbitrary combination such as connection to different cellular operator networks 12 or use of Dual Connectivity. The cellular operator network 12 is a carrier network defined by 3GPP. The cellular operator network 12 is configured to include a Radio Access Network (RAN) 31 and a Core network 32.

The RAN 31 is connected to the wireless communication unit 24 of the terminal 11 via wireless communication, and provides a wireless communication function for the terminal 11 to access the Internet 14 via the cellular operator network 12

The Core network 32 manages sessions and mobility of the terminals 11 and provides connection from the RAN 31 to the Internet 14.

The server 13 receives and reproduces the video data. The server 13 is configured to include a reception control unit 41 and a video reproduction unit 42.

The reception control unit 41 performs reception processing such as sequential control on a packet that has arrived via the plurality of communication channels.

The video reproduction unit 42 decodes the received video data.

<Functional Configuration Example of Each Unit of Terminal>

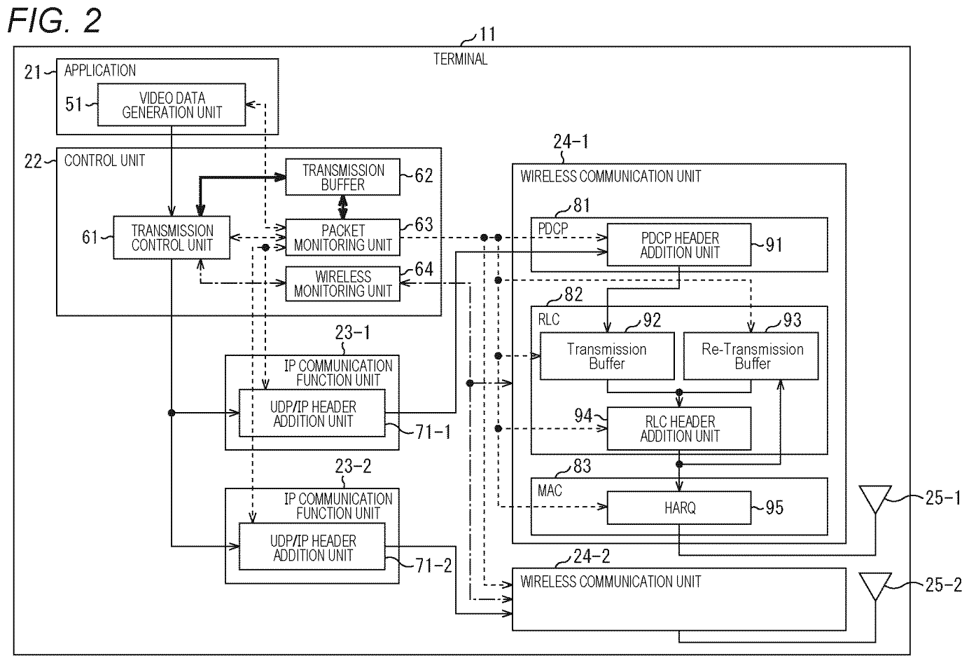

FIG. 2 is a block diagram illustrating a functional configuration example of each unit of the terminal 11.

The application 21 is configured to include a video data generation unit 51 that generates video data.

In a case where availability of the plurality of communication channels is notified from a transmission control unit 61 of the control unit 22, the application 21 notifies the transmission control unit 61 of identification information for identifying a packet having high importance.

The control unit 22 includes the transmission control unit 61, a transmission buffer 62, a packet monitoring unit 63, and a wireless monitoring unit 64.

In FIG. 2, the solid arrows indicate a flow of data. The dashed arrows indicate packet monitoring by a packet monitoring unit 63. The thick arrows indicate control of recording or dropping a packet with respect to the transmission buffer 62. The dash-dot arrows indicate operation performed by the wireless monitoring unit 64.

The transmission control unit 61 is connected to the transmission buffer 62, the packet monitoring unit 63, and the wireless monitoring unit 64 to perform transmission control.

Specifically, in a case where the plurality of communication channels is available, the transmission control unit 61 notifies the application 21 that the plurality of communication channels is available.

The transmission control unit 61 selects the packet having high importance on the basis of packet identification information notified from the application 21 and makes a backup on the transmission buffer 62. In a case where the transmission control unit 61 transmits the video data, the transmission control unit 61 determines, for example, whether or not the packet includes an I-frame, and, if the packet includes the I-frame, stores the packet in the transmission buffer 62.

The transmission control unit 61 determines and switches to the communication channel to be used, on the basis of the characteristic information of the communication channel notified by the wireless monitoring unit 64. For example, in a case where instantaneous interruption of the communication channel due to a handover, an increase in delay time due to a weak electric field, or the like is detected or predicted, the transmission control unit 61 switches the communication channel to another communication channel having a better characteristic until a characteristic of the former communication channel is recovered.

Furthermore, in a case where there is other data remaining in the transmission buffer 62 for a long time, the transmission control unit 61 makes a determination on the basis of a state of the transmission buffer 62 by using, for example, switching of the communication channel as a trigger.

When sensing an instantaneous interruption of a communication channel, such as a handover, and switching to a new communication channel, the transmission control unit 61 checks the state of the transmission buffer 62, and in a case where any un-transmitted packet remains, performs transmission starting with the packet.

Furthermore, in a case where the transmission control unit 61 has determined that the packet remaining in the transmission buffer 62 for a long time cannot be delivered to the server 13 within a necessary time, the transmission control unit 61 drops the packet and preferentially transmits a subsequent packet including an I-frame.

The transmission buffer 62 stores packets to be transmitted. The transmission buffer 62 stores and reads a selected packet under control of the transmission control unit 61. The transmission buffer 62 drops the transmitted packet under control of the packet monitoring unit 63. The packet monitoring unit 63 is connected to the application 21, the IP communication function unit 23, and each unit in each wireless communication unit 24 to monitor the packet.

Note that, as will be described in detail later, the IP communication function unit 23-1 is configured to include a UDP/IP header addition unit 71-1. The IP communication function unit 23-2 is configured to include a UDP/IP header addition unit 71-2. The UDP/IP header addition units 71-1 and 71-2 are referred to as a UDP/IP header addition unit 71 in a case where they are not particularly need to be distinguished from each other.

The wireless communication unit 24-1 includes each of a PDCP layer 81, an RLC layer 82, and a MAC layer 83. Note that, although not illustrated, the wireless communication unit 24-2 is configured similarly to the wireless communication unit 24-1.

Specifically, the packet monitoring unit 63 acquires a sequence number (SN) of a real-time transport protocol (RTP) packet (hereinafter, referred to as RTP SN) storing data including an I-frame, from among video data generated by the video data generation unit 51, and records the RTP SN.

The packet monitoring unit 63 acquires a UDP header corresponding to an RTP packet and records the UDP header.

The packet monitoring unit 63 acquires a PDCP SN assigned to the UDP header by using the PDCP, and records a correspondence between the UDP header and the PDCP SN.

Once stored in a Transmission Buffer 92 of the RLC layer 82, the packet is segmented or combined, and an RLC SN is added, and therefore, the packet monitoring unit 63 records a correspondence between the PDCP SN and the RLC SN.

In the MAC layer 83, the packet monitoring unit 63 monitors a state of a Hybrid Automatic Repeat reQuest (HARQ) 95 at a time of sending including a corresponding RLC packet, and records a status as transmitted at a timing when an ACK is received.

When statuses of all MAC packets associated with one RTP packet are transmitted, the packet monitoring unit 63 deletes a corresponding RTP packet from the transmission buffer 62.

The wireless monitoring unit 64 monitors a state of each wireless communication unit 24, and in a case where the wireless monitoring unit 64 has sensed a change in a wireless environment due to a handover, insufficient bandwidth due to a weak electric field such as a cell edge, occurrence of a radio link failure, or the like, makes a notification to the transmission control unit 61.

The UDP/IP header addition unit 71 adds the UDP header and an IP header to the packet transmitted from the transmission control unit 61 and transfers the packet to a corresponding wireless communication unit 24.

The wireless communication unit 24 is configured to include a PDCP header addition unit 91 as a functional unit of the PDCP layer 81.

The PDCP header addition unit 91 adds a PDCP header to an IP packet to be transmitted.

The wireless communication unit 24 is configured to include the Transmission Buffer 92, a Re-Transmission Buffer 93, and an RLC header addition unit 94 as functional units of the RLC layer 82.

The Transmission Buffer 92 temporarily stores a packet before wireless transmission.

The Re-Transmission Buffer 93 stores a packet until re-transmission processing is performed in the MAC layer 83 after a packet transmission failure.

The RLC header addition unit 94 combines or divides a PDCP packet as necessary, and then adds an RLC header.

The wireless communication unit 24 is configured to include an HARQ 95 as a functional unit of the MAC layer 83.

The HARQ 95 performs re-transmission in a case where the packet is not delivered correctly. Furthermore, the HARQ 95 returns the packet to the Re-Transmission Buffer 93 in a case where the packet transmission fails after being attempted a specified number of times.

### <Transmission Sequence of Video Data>

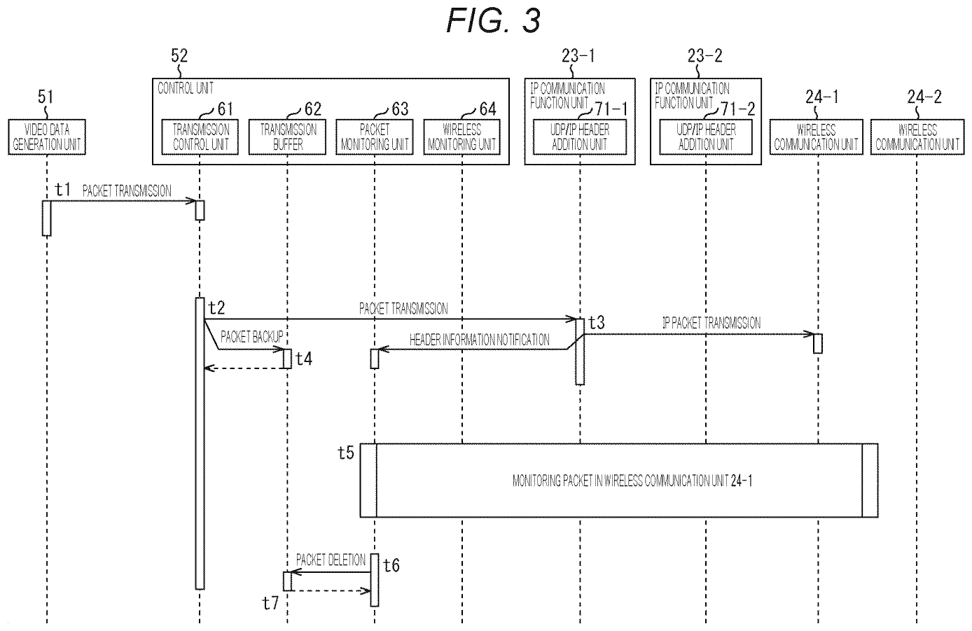

FIG. 3 is a diagram illustrating a sequence of transmitting video data in the wireless communication system 1 in FIG. 1, in a case of a packet that constitutes an I-frame.

FIG. 3 illustrates a sequence in a case where, when video data is sent, a communication channel to which the wireless communication unit 24-1 corresponds is mainly used, and a communication channel to which the wireless communication unit 24-2 corresponds is for a backup use.

Note that, in FIG. 3, each of the rectangles on the vertical lines each representing each unit indicates that corresponding processing is performed during a period denoted by the rectangle. It similarly applies to the subsequent drawings illustrating the sequences.

As a premise, the wireless communication units 24-1 and 24-2 complete, in advance, location registration in different or the same cellular operator network 12 according to a procedure defined by 3GPP.

Furthermore, the transmission control unit 61 notifies the application 21 that the plurality of communication channels is available, and receives from the application 21 the packet identification information for identifying a packet having high importance.

For example, in a case where an H.264 codec is used, by performing filtering such that a packet having a value of nal_unit_type in a packet payload set to “5” as the packet identification information is a packet having high importance, it is possible to extract an instant decoder refresh (IDR) packet corresponding to an I-frame in the H. 264 codec. Note that the above premise is similarly applied to the following drawings.

At a timing t1, the video data generation unit 51 generates the RTP packet and transmits the RTP packet to the transmission control unit 61.

The transmission control unit 61 determines whether or not the packet is a packet that constitutes the I-frame. In a case where the transmission control unit 61 has determined that the packet is a packet that constitutes the I-frame, at a timing t2, the transmission control unit 61 transmits the packet to the IP communication function unit 23-1 and stores the packet in the transmission buffer 62 to make a backup.

At a timing t3, the IP communication function unit 23-1 generates the IP packet by adding a necessary header, that is, information of the UDP header and IP header, to the received RTP packet, and transmits the generated IP packet by using the wireless communication unit 24-1.

At this time, the IP communication function unit 23-1 transmits, to the packet monitoring unit 63, the information of the UDP header and IP header added to the corresponding RTP packet. The packet monitoring unit 63 records the RTP SN of the corresponding RTP packet and the information of the UDP header and IP header added by the UDP/IP header addition unit 71-1 in association with each other, so that the wireless communication unit 24 can check a transmission status of a corresponding packet.

At a timing t4, the transmission buffer 62 notifies the transmission control unit 61 of completion of the backup.

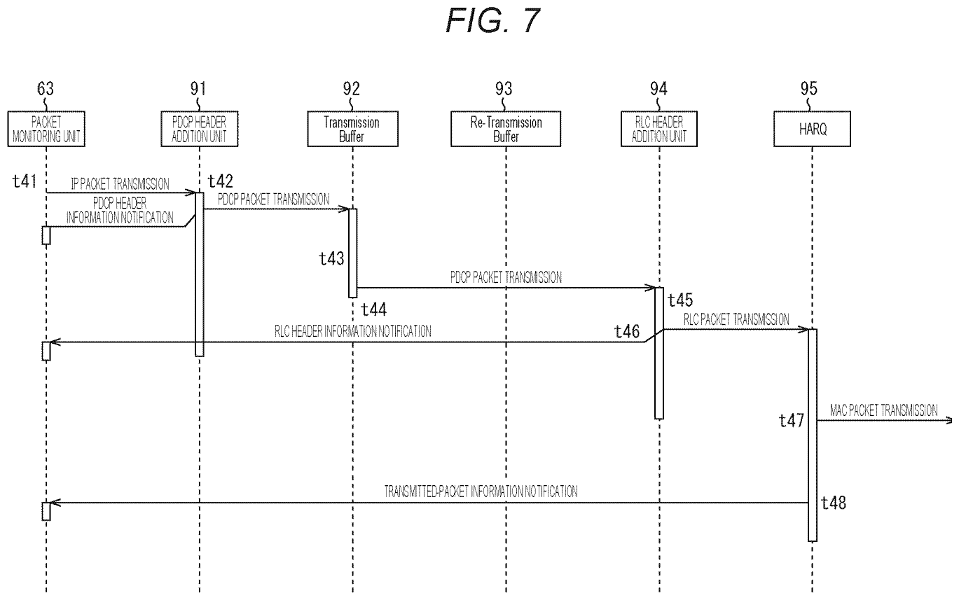

At a timing t5, the packet monitoring unit 63 monitors a transmission status of a packet in the wireless communication unit 24-1. Processing of monitoring the packet transmission status will be described later with reference to FIG. 7.

At a timing t6, the packet monitoring unit 63 detects that the transmission of the RTP packet that constitutes the I-frame is completed in the wireless communication unit 24-1, and instructs deletion of the RTP packet stored in the transmission buffer 62.

At a timing t7, the transmission buffer 62 deletes the stored RTP packet and notifies the packet monitoring unit 63 of the deletion.

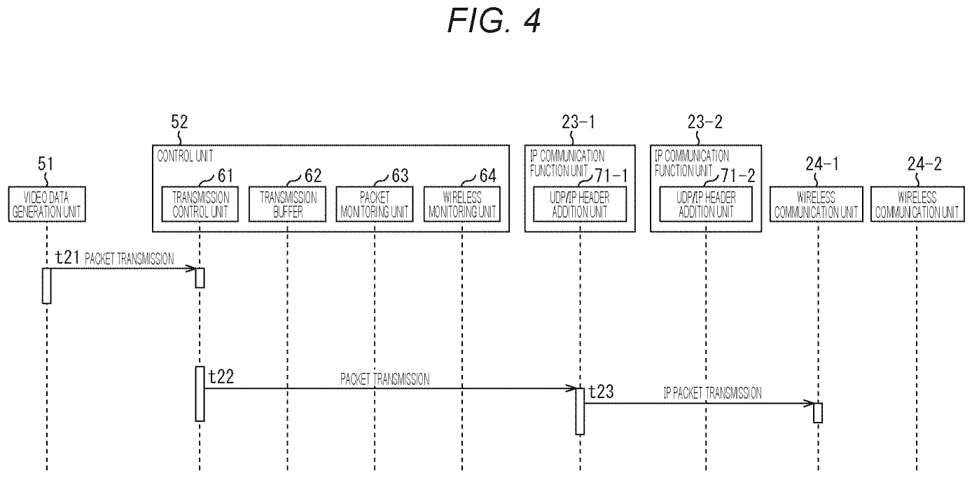

FIG. 4 is a diagram illustrating a sequence of transmitting the video data in a wireless communication system 1 in FIG. 1, in a case of a packet that constitutes a frame other than the I-frame.

At a timing t21, the video data generation unit 51 generates the RTP packet and transmits the RTP packet to the transmission control unit 61.

The transmission control unit 61 determines whether or not the packet is a packet that constitutes the I-frame. In a case where the transmission control unit 61 has determined that the packet is not a packet that constitutes the I-frame, at a timing t22, the transmission control unit 61 transmits the RTP packet to the IP communication function unit 23-1.

At a timing t23, the IP communication function unit 23-1 generates the IP packet by adding the UDP header and IP header to the received RTP packet, and transmits the generated IP packet by using the wireless communication unit 24-1.

By applying the above sequence to all the RTP packets generated by the video data generation unit 51, an RTP packet that constitutes the I-frame and is remaining in the wireless communication unit 24-1 can be backed up in the transmission buffer 62.

### <Packet Status Management>

Next, a method for managing a status (transmission status) of the packet passing through the wireless communication unit 24 will be described.

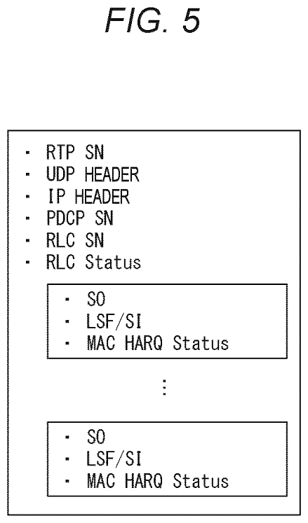

FIG. 5 is a diagram illustrating a configuration example of packet status management data.

The packet monitoring unit 63 holds the packet status management data illustrated in FIG. 5, and manages the packet transmission status while monitoring the packet and updating this information.

The packet status management data includes the RTP SN, the UDP header, the IP header, an RDCP SN, the RLC SN, and an RLC Status.

Note that, as illustrated in FIG. 5, the RLC Status includes a Segment Offset (SO), a Last Segment Flag (LSF) or Segmentation Info (SI), and a MAC HARQ Status.

In this regard, however, there is a possibility that the packet is divided in the RLC layer, and in a case where the packet is divided, a plurality of SOs, LSFs or SI, and MAC HARQ Statuses are added to one RTP SN.

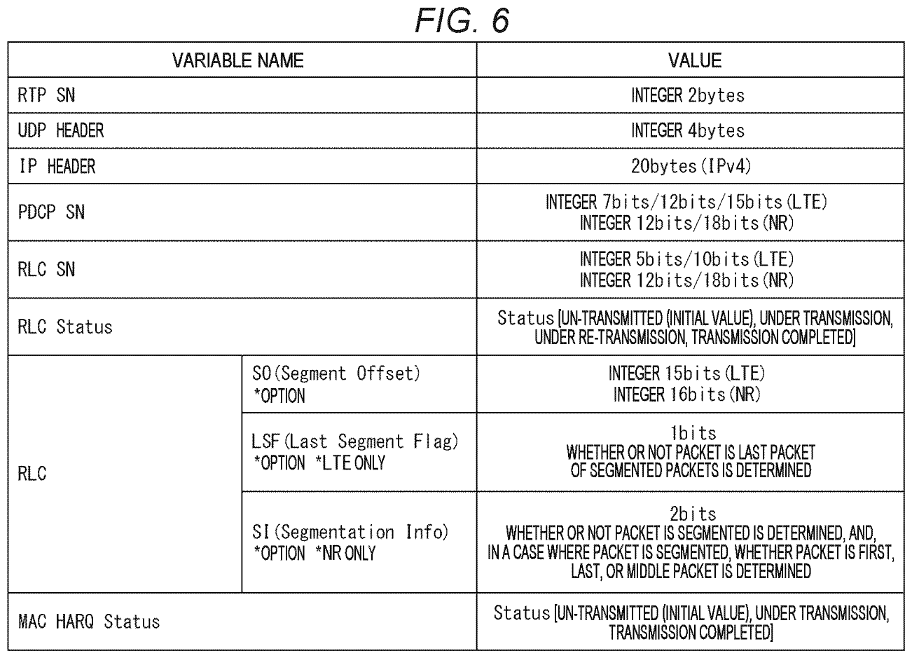

FIG. 6 is a diagram illustrating details of the packet status management data (variables) in FIG. 5.

The RTP SN includes an integer of 2 bytes.

The UDP header includes an integer of 4 bytes. In a case of IPV4, the IP header includes an integer of 20 bytes.

In a case of Long Term Evolution (LTE), the RDCP SN includes an integer of 7 bits, 12 bits, or 15 bits. Furthermore, the RDCP SN includes an integer of 12 bits or 18 bits in a case of New Radio (NR).

In a case of the LTE, the RLC SN includes an integer of 5 bits or 10 bits. Furthermore, in a case of the NR, the RLC SN includes an integer of 12 bits or 18 bits.

The RLC Status includes a Status [un-transmitted (initial value), under transmission, under re-transmission, transmission completed].

The SO in the RLC is an option. The SO in the RLC includes an integer of 15 bits (LTE) in a case of the LTE, and includes an integer of 16 bits in a case of the NR.

The LSF in the RLC is an option in a case of the LTE. The LSF in the RLC includes an integer of 1 bit for determining whether or not the packet is a last packet of segmented packets.

The SI in the RLC is an option in a case of the NR. The SI in the RLC includes an integer of 2 bits for determining whether or not the packet is segmented, and, in a case where the packet is segmented, whether the packet is a first, last or middle packet.

The MAC HARQ Status includes a Status [un-transmitted (initial value), under transmission, transmission completed].

When transmitting the I-frame, the packet monitoring unit 63 monitors the packet transmission status by managing a status of each layer of the PDCP 81, the RLC 82, and the MAC 83 of the wireless communication unit 24 in association with the RTP SN, the UDP header, and the IP header. After the IP packet is transmitted from the IP communication function unit 23 to the wireless communication unit 24, the packet monitoring unit 63 performs processing of monitoring the packet transmission status. Processing of monitoring the packet transmission status will be described with reference to FIG. 7 below.

### <Packet Transmission Status Monitor Processing Sequence>

FIG. 7 is a diagram illustrating a first sequence for performing processing of monitoring a packet transmission status in the wireless communication unit 24-1 at the timing t5 in FIG. 3.

Note that FIG. 7 illustrates a sequence in a case where the MAC packet is successfully transmitted in the HARQ 95.

At a timing t41, the IP communication function unit 23-1 transmits the IP packet to the PDCP header addition unit 91. Note that the processing at the timing t41 is processing corresponding to the processing at the timing t3 in FIG. 3.

At a timing t42, the PDCP header addition unit 91 adds the PDCP header to the IP packet and transmits the IP packet to the Transmission Buffer 92. Furthermore, the PDCP header addition unit 91 notifies the packet monitoring unit 63 of the PDCP SN included in the added header. The packet monitoring unit 63 updates information of the PDCP SN of the status management data.

At a timing t43, the Transmission Buffer 92 buffers the PDCP packet until a transmission opportunity is provided. Furthermore, in the Transmission Buffer 92, packet division or integration is performed as necessary at a time of transmission.

At a timing t44, the Transmission Buffer 92 transmits the PDCP packet to the RLC header addition unit 94.

At a timing t45, the RLC header addition unit 94 adds the RLC header to the PDCP packet transmitted from the Transmission Buffer 92.

At a timing t46, the RLC header addition unit 94 transmits, to the HARQ 95 of the MAC layer 83, the RLC packet to which the RLC header is added, and notifies the packet monitoring unit 63 of the RLC SN included in the added RLC header. The packet monitoring unit 63 updates information of the RLC SN of the status management data.

Note that, in a case where the PDCP packet is not divided or integrated, the so indicating that the packet is a segmented packet and the LSF indicating that the packet is the last packet of the segmented packets used in the LTE are not used, and thus, these pieces of information do not need to be monitored. Furthermore, “00b” representing undividedness is stored for the SI used in the NR, and the packet monitoring unit 63 changes the RLC Status of the held status management data to “under transmission” and the MAC HARQ Status to “under transmission”.

Meanwhile, in a case where the PDCP packet is divided into a plurality of segments, the SO indicating a start position of a divided packet and the LSF or SI corresponding thereto are added. Therefore, the packet monitoring unit 63 records information of these assigned values. The packet monitoring unit 63 changes the RLC Status to “under transmission”, and, each time the divided RLC packet is transmitted to the MAC layer 83, changes a corresponding MAC HARQ Status to “under transmission”.

At a timing t47, the HARQ 95 successfully transmits the MAC packet or transmits the MAC packet up to an upper limit number of times of re-transmission.

Because the MAC packet has been successfully transmitted, the HARQ 95 notifies the packet monitoring unit 63 of transmitted-packet information at a timing t48. The packet monitoring unit 63 changes the MAC HARQ Status of a corresponding packet to “transmission completed”. The packet monitoring unit 63 also changes the RLC Status to “transmission completed” when all the MAC HARQ Statuses associated with a specific RTP SN are changed to “transmission completed”.

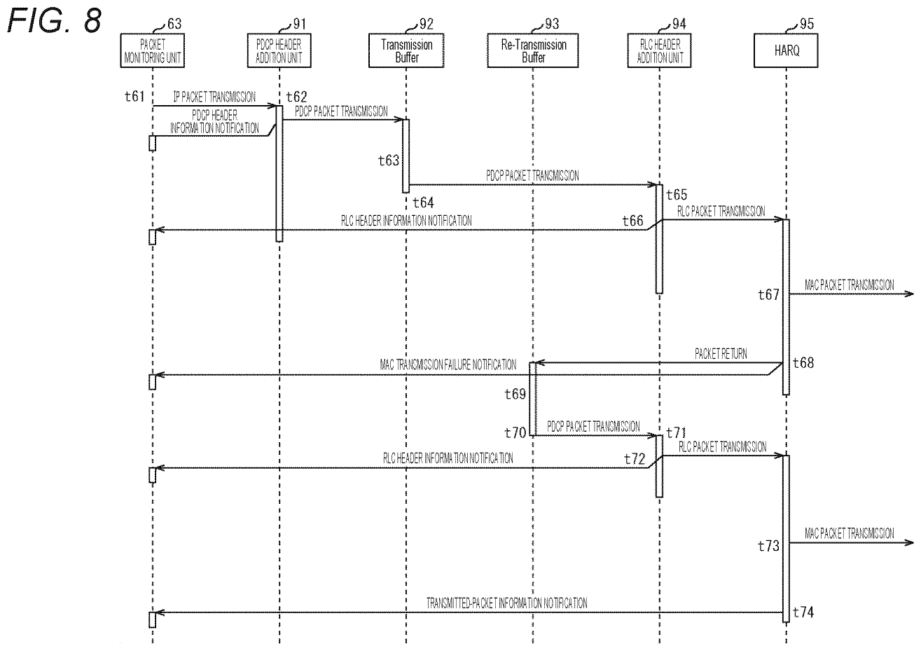

FIG. 8 is a diagram illustrating a second sequence for performing processing of monitoring a packet transmission status in the wireless communication unit 24-1 at the timing t5 in FIG. 3.

Note that FIG. 8 illustrates a sequence in a case where transmission of the MAC packet has failed in the HARQ 95.

Because processing at timings t61 to t67 in FIG. 8 is basically similar to the processing at the timings t41 to t47 in FIG. 7, description thereof will be omitted.

Because the transmission of the MAC packet has failed, at a timing t68, the HARQ 95 returns, to the Re-Transmission Buffer 93, the packet of which transmission has failed, and notifies the packet monitoring unit 63 that the packet transmission has failed. The packet monitoring unit 63 changes RLC Status to “under re-transmission”.

Note that, at this time, because there is a possibility that the packet is divided or integrated, when re-transmission is to be performed with the RLC, information of the SO and LSF/SI that has been initially added is dropped once.

Thereafter, the PDCP packet is transmitted again in a procedure similar to the procedure used at a time of first transmission.

That is, at a timing t69, the Re-Transmission Buffer 93 buffers the PDCP packet until a transmission opportunity is provided. Furthermore, in the Re-Transmission Buffer 93, packet division or integration is performed as necessary at a time of transmission.

At a timing t70, the Re-Transmission Buffer 93 transmits the PDCP packet to the RLC header addition unit 94.

At a timing t71, the RLC header addition unit 94 adds the RLC header to the PDCP packet transmitted from the Re-Transmission Buffer 93.

At a timing t72, the RLC header addition unit 94 transmits, to the HARQ 95 of the MAC layer 83, the RLC packet to which the RLC header is added, and notifies the packet monitoring unit 63 of the RLC SN included in the added RLC header. The packet monitoring unit 63 updates information of the RLC SN of the status management data.

At a timing t73, the HARQ 95 successfully transmits the MAC packet or transmits the MAC packet up to an upper limit number of times of re-transmission.

Because the MAC packet has been successfully transmitted, the HARQ 95 notifies the packet monitoring unit 63 of transmitted-packet information at a timing t74. The packet monitoring unit 63 changes the MAC HARQ Status of a corresponding packet to “transmission completed”. The packet monitoring unit 63 also changes the RLC Status to “transmission completed” when all the MAC HARQ Statuses associated with a specific RTP SN are changed to “transmission completed”.

Because the transmission status of the packet is monitored in such a sequence, it can be seen that transmission of a corresponding RTP packet in a wireless section is completed when the RLC Status is changed to a “transmission completed” state. Therefore, the packet monitoring unit 63 can drop the corresponding RTP packet from the transmission buffer 62.

### <Communication Channel Switching Sequence Accompanying Handover>

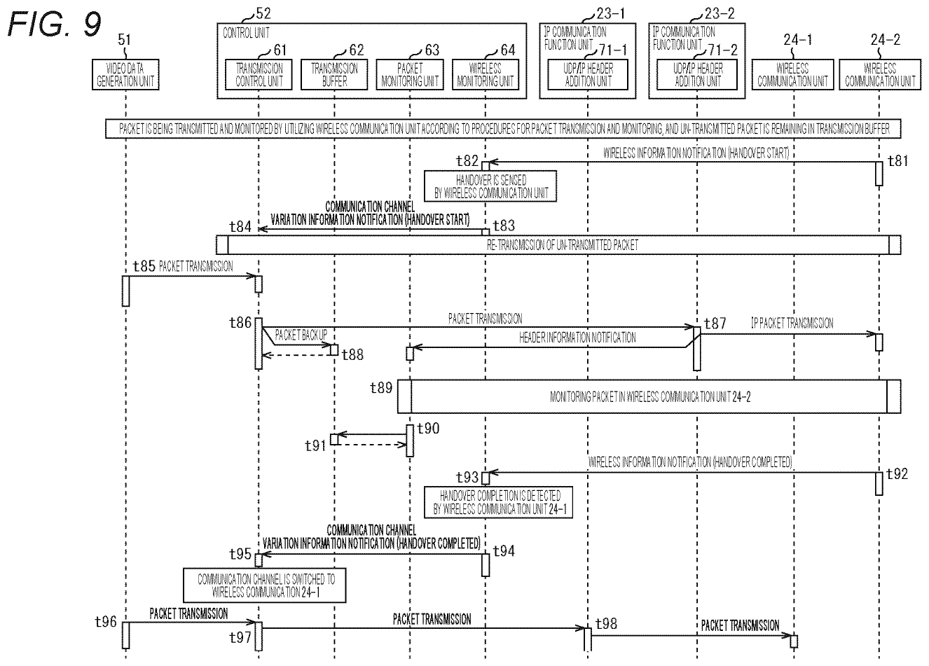

FIG. 9 is a diagram illustrating a communication channel switching sequence accompanying a handover, in a case of the packet that constitutes the I-frame.

FIG. 9 illustrates a sequence in a case where, when video data is sent, a communication channel using the wireless communication unit 24-1 is mainly used, and a communication channel using the wireless communication unit 24-2 is for a backup use.

The sequence in FIG. 9 illustrates a flow in a situation where an instantaneous interruption of a communication channel accompanying a handover occurs while video data is being transmitted by using the wireless communication unit 24-1 at first, a packet including an I-frame and remaining in the wireless communication unit 24-1 is re-transmitted by using the wireless communication unit 24-2, communication is then continued for a while by using the wireless communication unit 24-2, and after the handover is completed in the wireless communication unit 24-1, the wireless communication unit is switched to the wireless communication unit 24-1 again to transmit data.

As a premise, the wireless communication units 24-1 and 24-2 complete, in advance, location registration in different or the same cellular operator network in accordance with a sequence defined by 3GPP, and store packets in the transmission buffer 62 and monitor the packets in accordance with the sequences illustrated in FIGS. 3, 4, 7, and 8. Furthermore, the wireless monitoring unit 64 monitors wireless communication statuses of the wireless communication units 24-1 and 24-2.

At a timing t81, the wireless communication unit 24-1 detects start of the handover and notifies the wireless monitoring unit 64 of the start of the handover.

At a timing t82, the wireless monitoring unit 64 senses that the instantaneous interruption accompanying the handover occurs.

At a timing t83, the wireless monitoring unit 64 notifies the transmission control unit 61 of the occurrence of the instantaneous interruption accompanying the handover in the wireless communication unit 24-1.

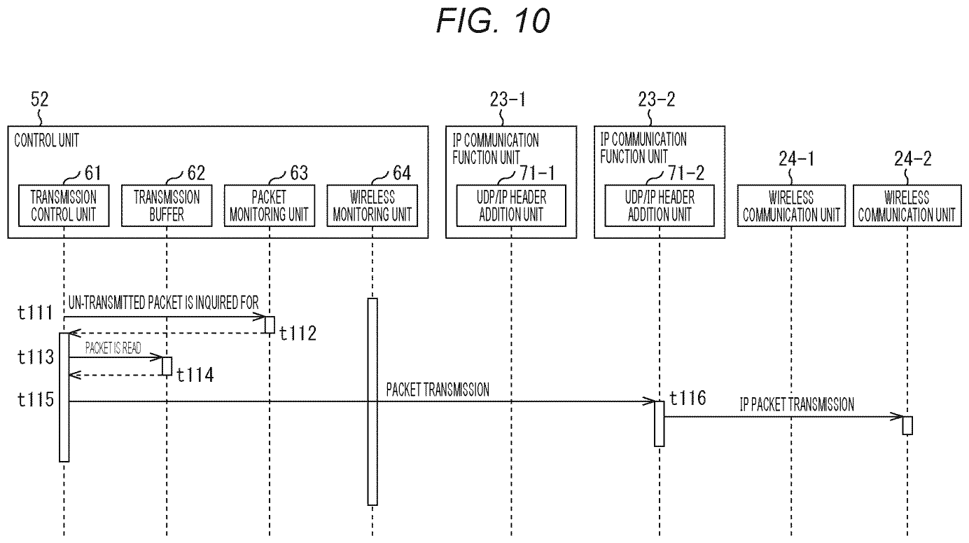

At a timing t84, the transmission control unit 61 performs re-transmission processing of an un-transmitted packet. The re-transmission processing of the un-transmitted packet, which will be described later with reference to FIG. 10, is repeatedly performed until the transmission buffer 62 is empty.

After completion of the re-transmission processing of the un-transmitted packet, the transmission control unit 61 performs packet transmission with respect to the wireless communication unit 24-2 at timings t85 to t91.

Note that the processing at the timings t85 to t91 is basically similar to the processing at the timings t1 to t7 in FIG. 3 except that a transmission destination of the packet is changed from the wireless communication unit 24-1 to the wireless communication unit 24-2, and thus description thereof is omitted. In this regard, however, because the wireless communication unit 24-1 and the wireless communication unit 24-2 are independent, it is necessary to prepare different pieces of status management data, except for the RTP SN.

Furthermore, the processing at the timings t85 to t91 are repeatedly performed in the wireless communication unit 24-1 until the handover is completed.

At a timing t92, the wireless communication unit 24-1 detects the completion of the handover and notifies the wireless monitoring unit 64 of the completion of the handover.

At a timing t93, the wireless monitoring unit 64 detects that the handover is completed.

At a timing t94, the wireless monitoring unit 64 notifies the transmission control unit 61 of the completion of the handover.

At a timing t95, the transmission control unit 61 switches the communication channel to be used to the wireless communication unit 24-1. Subsequent packet transmission is performed via the wireless communication unit 24-1.

Note that timings t96 to t98 are similar to the packet transmission processing of the video data in a case of the packet that constitutes a frame other than the I-frame at the timings t21 to t23 in FIG. 4, and thus the description thereof will be omitted. Note that, in a case of the packet that constitutes the I-frame, the processing in FIG. 3 is repeatedly performed.

Here, regarding control at a time of switching operation at the timing t95, if an event such as a handover that deteriorates a communication characteristic does not occur in a wireless communication unit 94-2 when switching back to an original communication channel, processing of reading the transmission buffer 62 and re-transmission with the wireless communication unit 24-1 does not need to be performed for packets being transmitted in the wireless communication unit 94-2.

Furthermore, in a case where the transmission control unit 61 determines that there is a packet remaining in the transmission buffer 62 for a long time due to, for example, taking time to detect a handover, and therefore that the I-frame cannot be delivered to the server 13 within a necessary time, the transmission control unit 61 may perform either of the following operations.
To drop a subsequent P-frame and preferentially transmit a next I-frame
To determine switching of communication channel triggered by the packet remaining in the wireless communication unit 24 for a long time

### <Un-Transmitted Packet Re-Transmission Processing Sequence>

FIG. 10 is a diagram illustrating the un-transmitted packet re-transmission processing sequence at the timing t84 in FIG. 9.

At a timing t111, the transmission control unit 61 checks whether or not there is an un-transmitted packet in the packet monitoring unit 63.

For example, an RTP packet having the RLC Status in “un-transmitted”, “under transmission”, or “under re-transmission” is data remaining in the wireless communication unit 24-1.

At a timing t112, the packet monitoring unit 63 notifies the transmission control unit 61 of information of data remaining in the wireless communication unit 24-1.

At a timing t113, the transmission control unit 61 issues an instruction to read a corresponding RTP packet from the transmission buffer 62.

At a timing t114, the corresponding RTP packet is read from the transmission buffer 62 by the transmission control unit 61 according to an instruction from the transmission control unit 61.

At a timing t115, the transmission control unit 61 transmits a packet to the UDP/IP header addition unit 71-2 in order to transmit the I-frame data via the wireless communication unit 24-2.

At a timing t116, the UDP/IP header addition unit 71-2 adds a UDP/IP header and transmits, to the wireless communication unit 24-2, the IP packet to which the header is added.

Note that the processing in FIG. 10 is repeatedly performed until the transmission buffer 62 is empty.

### <Communication Channel Switching Sequence Accompanying Handover>

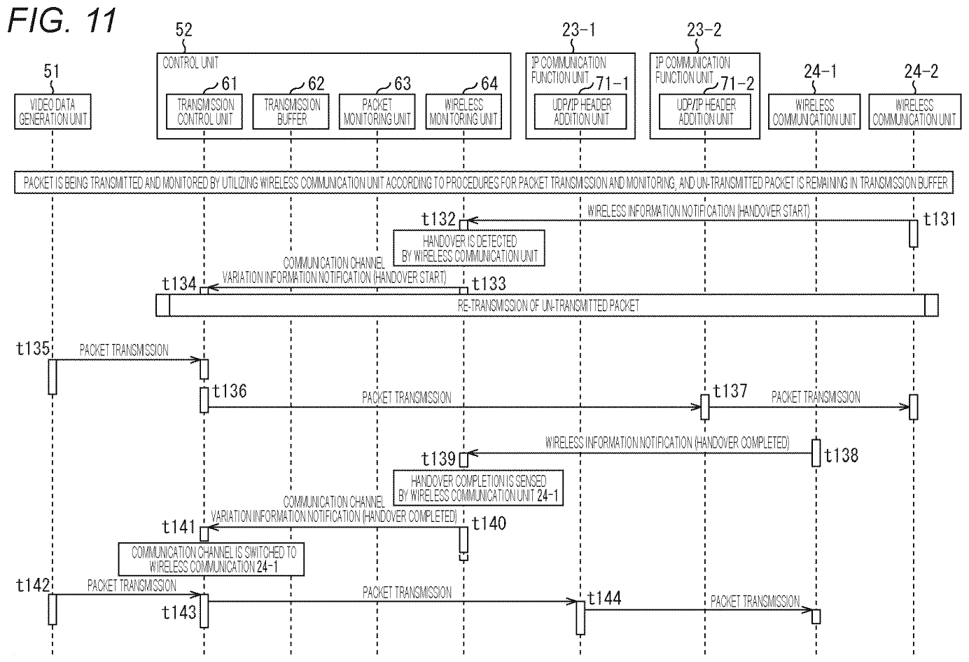

FIG. 11 is a diagram illustrating a communication channel switching sequence accompanying a handover, in a case of a packet that constitutes a frame other than the I-frame.

Note that processing at timings t131 to t134 in FIG. 11 is basically similar to the processing at the timings t81 to t84 in FIG. 9, description thereof will be omitted.

At a timing t135, the video data generation unit 51 generates the RTP packet and transmits the RTP packet to the transmission control unit 61.

The transmission control unit 61 determines whether or not the packet is a packet that constitutes the I-frame. In a case where it is determined that the packet is not a packet that constitutes the I-frame, at a timing t136, the transmission control unit 61 transmits the packet to the IP communication function unit 23-2.

At a timing t137, the IP communication function unit 23-2 generates the IP packet by adding a necessary header, and transmits the generated IP packet by using the wireless communication unit 24-2.

Note that the processing at the timings t135 to t137 are repeatedly performed in the wireless communication unit 24-1 until the handover is completed.

Furthermore, because processing at timings t138 to t144 is basically similar to the processing at the timings t92 to t98 in FIG. 9, description thereof will be omitted.

### 2. Modifications

### <Method for Implementing Packet Monitoring Unit>

To facilitate implementation, the packet monitoring unit 63 can take the following forms.

A maximum remaining time at a portion of the HARQ 95 of the MAC layer 83 can be estimated from a parameter of the RLC. Therefore, the packet monitoring unit 63 excludes the MAC layer 83 from monitoring targets, and treats a packet that has passed through the RLC layer 82 yet has not passed for a certain period of time or longer as an un-transmitted packet remaining in the HARQ 95.

On the basis of a value of a Buffer Status Report notified from the terminal 11 to a base station 12, the transmission control unit 61 estimates a packet remaining in the wireless communication unit 24. In this case, the packet monitoring unit 63 is only required to monitor only amounts of an RLC service data unit (SDU) and an RLC protocol data unit (PDU) in the wireless communication unit 24.

By extending the monitoring target not only to the I-frame but also to all frames, the packet monitoring unit 63 can be configured to be able to transmit frames starting with un-transmitted frames through another route, regardless of a type of the frames, such as the I-frame or the P-frame.

### <Installation Location of Packet Monitoring Unit>

In the above-described embodiment, the video data is transmitted from the terminal 11 in an up link (UL) direction, but video data in a down link (DL) direction can be applied by installing the packet monitoring unit 63 in each base station 1 and returning a similar feedback to the transmission control unit 61 installed in the server 13.

Note that, although the cellular operator network has been described in the present embodiment, the present technology is not limited to cellular communication, and is also applied to a communication method such as Wi-Fi communication, which is other than cellular communication. That is, a combination of the plurality of communication channels may be a combination of Wi-Fi communication networks or a combination of a cellular operator network and a Wi-Fi communication network.

### 3. Others

### <Effects of Present Technology>

As described above, in the present technology, transmission of a packet by using the plurality of communication channels is controlled, the packet is transmitted by using a first communication channel, the packet is transmitted by using a second communication channel, and the packet is temporarily accumulated in a transmission buffer. Then, in a case where a characteristic of the first communication channel deteriorates during transmission of the packet using the first communication channel, the packet of which transmission on the first communication channel is not completed is read from the transmission buffer, and transmission of the read packet using the second communication channel is controlled.

Therefore, degradation in video quality can be reduced in a case where a characteristic of a communication channel deteriorates.

### <Configuration Example of Computer>

The series of processing described above can be executed by hardware and also can be executed by software. In a case where the series of processing is executed by software, a program included in the software is installed from a program recording medium to a computer incorporated in dedicated hardware, a general-purpose personal computer, or the like.

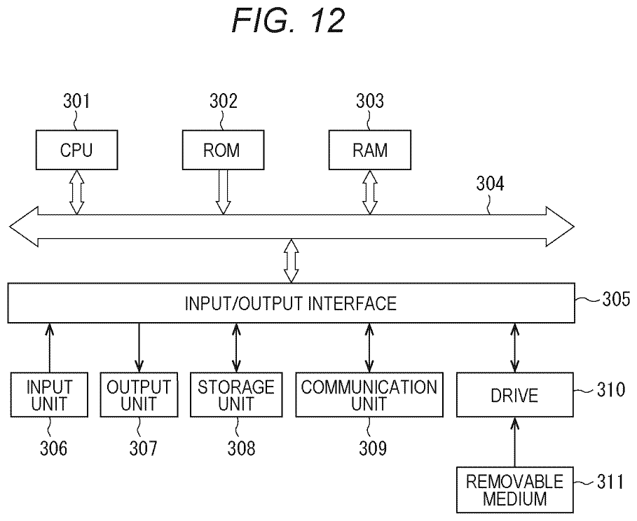

FIG. 12 is a block diagram illustrating a configuration example of hardware of a computer that performs the series of processing described above in accordance with a program.

A central processing unit (CPU) 301, a read only memory (ROM) 302, and a random access memory (RAM) 303 are connected to each other by a bus 304.

Moreover, an input/output interface 305 is connected to the bus 304. To the input/output interface 305, an input unit 306 including a keyboard, a mouse, and the like, and an output unit 307 including a display, a speaker, and the like are connected. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, the above-described series of processing steps is executed, for example, by the CPU 301 loading the program stored in the storage unit 308 into the RAM 303 via the input/output interface 305 and the bus 304 and executing the program.

The program to be executed by the CPU 301 is provided, for example, by being recorded on the removable medium 311 or via a wired or wireless transmission medium such as a local area network, the Internet, or digital broadcasting, and is installed on the storage unit 308.

Note that the program executed by the computer may be a program in which processing is performed in time series in the order described in the present specification or may be a program in which processing is performed in parallel or at necessary timing such as when a call is made.

Note that, in the present specification, a system means an assembly of a plurality of components (apparatuses, modules (parts), and the like), and it does not matter whether or not all the components are located in the same housing. Therefore, a plurality of apparatuses housed in separate housings and connected to each other via a network and one apparatus in which a plurality of modules is housed in one housing are both systems.

Furthermore, the effects described in the present specification are merely examples and not restrictive, and there may also be other effects.

An embodiment of the present technology is not limited to the embodiment described above, and various modifications can be made without departing from the scope of the present technology.

For example, the present technology may be configured as cloud computing in which one function is shared by a plurality of apparatuses via a network and processing is executed in cooperation.

Furthermore, each step described in the above-described flowcharts can be executed by one apparatus or can be shared and executed by a plurality of apparatuses.

Moreover, in a case where a plurality of pieces of processing is included in one step, the plurality of pieces of processing included in the one step can be executed by one apparatus or executed by a plurality of apparatuses in a shared manner.

### <Configuration Combination Examples>

The present technology can also be configured as follows.

(1)

A wireless communication apparatus including
a transmission control unit that controls transmission of a packet using a plurality of communication channels,
a first wireless communication unit that transmits the packet by using a first communication channel,
a second wireless communication unit that transmits the packet by using a second communication channel, and
a transmission buffer that temporarily accumulates the packet, in which
in a case where a characteristic of the first communication channel deteriorates during transmission of the packet using the first communication channel, the transmission control unit reads, from the transmission buffer, the packet of which transmission on the first communication channel is not completed, and controls transmission of the read packet by using the second communication channel.

(2)

The wireless communication apparatus according to (1), further including a packet monitoring unit that monitors a transmission status of the packet in the first wireless communication unit and the second wireless communication unit, in which the transmission control unit reads, from the transmission buffer and on the basis of a transmission status of the packet, the packet of which transmission on the first communication channel has not yet been completed, and causes the second wireless communication unit to transmit the packet by using the second communication channel.

(3)

The wireless communication apparatus according to (2), in which the first wireless communication unit and the second wireless communication unit have wireless communication functions of a Packet Data Convergence Protocol (PDCP) layer, a Packet Data Convergence Protocol (RLC) layer, and a Packet Data Convergence Protocol (MAC) layer.

(4)

The wireless communication apparatus according to (3), further including a first IP communication function unit and a second IP communication function unit that have a wireless communication function of an IP layer, add an IP header to the packet supplied from the transmission control unit, and transmit the packet to the first wireless communication unit and the second wireless communication unit, respectively.

(5)

The wireless communication apparatus according to (4), in which the packet monitoring unit holds status management data that manages a transmission status of the packet in the IP layer, the PDCP layer, and the RLC layer.

(6)

The wireless communication apparatus according to (5), in which, in the RLC layer, the first wireless communication unit and the second wireless communication unit have a first buffer in which the packet to be transmitted is accumulated, and a second buffer in which the packet that is failed to be transmitted and is to be re-transmitted is accumulated, respectively.

(7)

The wireless communication apparatus according to (5), in which, in the MAC layer also, the status management data manages a transmission status of the packet.

(8)

The wireless communication apparatus according to any one of (1) to (7), in which the packet includes the packet including data having high importance.

(9)

The wireless communication apparatus according to (8), in which the transmission control unit does not accumulate the packet including data having low the importance in the transmission buffer, and controls transmission of the packet using the first communication channel or the second communication channel.

(10)

The wireless communication apparatus according to (8), in which
the packet includes video data, and
the data having high importance is an I-frame of the video data.

(11)

The wireless communication apparatus according to any one of (1) to (10), in which the first communication channel and the second communication channel are configured by a combination of enhanced Mobile Broadband (eMBB) and Ultra-Reliable and Low Latency Communications (URLLC).

(12)

The wireless communication apparatus according to (11), in which the first communication channel is the eMBB and the second communication channel is the URLLC.

(13)

The wireless communication apparatus according to any one of (1) to (12), in which the first communication channel and the second communication channel are configured by a combination of communication channels of different cellular operator networks.

(14)

The wireless communication apparatus according to any one of (1) to (13), the wireless communication apparatus including one housing.

(15)

A wireless communication method including, by wireless communication apparatus,
controlling transmission of a packet using a plurality of communication channels,
transmitting the packet by using a first communication channel,
transmitting the packet by using a second communication channel,
temporarily accumulating the packet in a transmission buffer, and
in a case where a characteristic of the first communication channel deteriorates during transmission of the packet using the first communication channel, reading, from the transmission buffer, the packet of which transmission on the first communication channel is not completed, and controlling transmission of the read packet by using the second communication channel.

### REFERENCE SIGNS LIST

1 Wireless communication system
11 Terminal
12, 12-1 to 12-3 Cellular operator network
13 Server
14 Internet
21 Application
22 Control unit
23, 23-1, 23-2 IP communication function unit
24, 24-1, 24-2 Wireless communication unit
25, 25-1, 25-2 Antenna
31 RAN
32 Core network
41 Reception control unit
42 Video reproduction unit
51 Video data generation unit
61 Transmission control unit
62 Transmission buffer
63 Packet monitoring unit
64 Wireless monitoring unit
71, 71-1, 71-2 UDP/IP header addition unit
81 PDCP layer
82 RLC layer
83 MAC layer
91 PDCP header addition unit
92 Transmission Buffer
93 Re-Transmission Buffer
94 RLC header addition unit
95 HARQ

1. A wireless communication apparatus comprising:
a transmission control unit that controls transmission of a packet using a plurality of communication channels;
a first wireless communication unit that transmits the packet by using a first communication channel;
a second wireless communication unit that transmits the packet by using a second communication channel; and
a transmission buffer that temporarily accumulates the packet, wherein
in a case where a characteristic of the first communication channel deteriorates during transmission of the packet using the first communication channel, the transmission control unit reads, from the transmission buffer, the packet of which transmission on the first communication channel is not completed, and controls transmission of the read packet by using the second communication channel.

2. The wireless communication apparatus according to claim 1, further comprising a packet monitoring unit that monitors a transmission status of the packet in the first wireless communication unit and the second wireless communication unit, wherein the transmission control unit reads, from the transmission buffer and on a basis of a transmission status of the packet, the packet of which transmission on the first communication channel has not yet been completed, and causes the second wireless communication unit to transmit the packet by using the second communication channel.

3. The wireless communication apparatus according to claim 2, wherein the first wireless communication unit and the second wireless communication unit have wireless communication functions of a Packet Data Convergence Protocol (PDCP) layer, a Packet Data Convergence Protocol (RLC) layer, and a Packet Data Convergence Protocol (MAC) layer.

4. The wireless communication apparatus according to claim 3, further comprising a first IP communication function unit and a second IP communication function unit that have a wireless communication function of an IP layer, add an IP header to the packet supplied from the transmission control unit, and transmit the packet to the first wireless communication unit and the second wireless communication unit, respectively.

5. The wireless communication apparatus according to claim 4, wherein the packet monitoring unit holds status management data that manages a transmission status of the packet in the IP layer, the PDCP layer, and the RLC layer.

6. The wireless communication apparatus according to claim 5, wherein, in the RLC layer, the first wireless communication unit and the second wireless communication unit have a first buffer in which the packet to be transmitted is accumulated, and a second buffer in which the packet that is failed to be transmitted and is to be re-transmitted is accumulated, respectively.

7. The wireless communication apparatus according to claim 5, wherein, in the MAC layer also, the status management data manages a transmission status of the packet.

8. The wireless communication apparatus according to claim 1, wherein the packet includes the packet including data having high importance.

9. The wireless communication apparatus according to claim 8, wherein the transmission control unit does not accumulate the packet including data having low the importance in the transmission buffer, and controls transmission of the packet using the first communication channel or the second communication channel.

10. The wireless communication apparatus according to claim 8, wherein
the packet includes video data, and
the data having high importance is an I-frame of the video data.

11. The wireless communication apparatus according to claim 1, wherein the first communication channel and the second communication channel are configured by a combination of enhanced Mobile Broadband (eMBB) and Ultra-Reliable and Low Latency Communications (URLLC).

12. The wireless communication apparatus according to claim 11, wherein the first communication channel is the eMBB and the second communication channel is the URLLC.

13. The wireless communication apparatus according to claim 1, wherein the first communication channel and the second communication channel are configured by a combination of communication channels of different cellular operator networks.

14. The wireless communication apparatus according to claim 1, the wireless communication apparatus including one housing.

15. A wireless communication method comprising, by a wireless communication apparatus,
controlling transmission of a packet using a plurality of communication channels,
transmitting the packet by using a first communication channel,
transmitting the packet by using a second communication channel,
temporarily accumulating the packet in a transmission buffer, and
in a case where a characteristic of the first communication channel deteriorates during transmission of the packet using the first communication channel, reading, from the transmission buffer, the packet of which transmission on the first communication channel is not completed, and controlling transmission of the read packet by using the second communication channel.
